(19) United States
(12) Patent Application Publication
(10) Pub. No.: US 2025/0056595 A1
(43) Pub. Date: Feb. 13, 2025

(54) DIFFERENT LOW-LATENCY PREEMPTION MODES FOR WIRELESS COMMUNICATIONS

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/800,617

(22) Filed: Aug. 12, 2024

Related U.S. Application Data
(60) Provisional application No. 63/644,396, filed on May 8, 2024.
(60) Provisional application No. 63/569,236, filed on Mar. 25, 2024.
(60) Provisional application No. 63/519,066, filed on Aug. 11, 2023.

(51) Int. Cl. H04W 72/566; H04L 5/00; H04W 72/23

(52) U.S. Cl. CPC H04W 72/569; H04L 5/0064; H04W 72/23

(57) ABSTRACT

Embodiments of a wireless device, a communications system and method are disclosed. In an embodiment, a wireless device comprises a wireless transceiver to receive and transmit frames, and a controller operably coupled to the wireless transceiver to process the frames, wherein the controller is configured to, in response to an enablement of a low-latency preemption mode from another wireless device, transmit a request for a low-latency preemption, and then transmit a low-latency frame to the another wireless device.

### CROSS-REFERENCE TO RELATED APPLICATIONS

This application is entitled to the benefit of U.S. Provisional Patent Application Ser. No. 63/519,066, filed on Aug. 11, 2023, U.S. Provisional Patent Application Ser. No. 63/569,236, filed on Mar. 25, 2024, and U.S. Provisional Patent Application Ser. No. 63/644,396, filed on Mar. 8, 2024, which are incorporated herein by reference.

### BACKGROUND

In order to decrease the latency of low-latency traffic in wireless communications, the low-latency traffic frames can be transmitted in several different ways in a transmission opportunity (TXOP) whose primary access category (AC) is for non-low-latency traffic. One way is that the low-latency frames of the TXOP holder can be transmitted. Another way is that the low-latency frames of the TXOP responder can be transmitted if permitted by the TXOP holder. Still another way is that the low-latency frames of the 3^{rd}-party stations (STAs) can be transmitted if permitted by the TXOP holder.

However, there may be potential issues with these ways to transmit the low-latency traffic. For example, a STA may preempt the other STA's TXOP while the STA does not allow the other STAs to do the preemption in its TXOP. As another example, the implementation of the preemption of 3^{rd}-party STAs may be complicated.

### SUMMARY

Embodiments of a wireless device, a communications system and method are disclosed. In an embodiment, a wireless device comprises a wireless transceiver to receive and transmit frames, and a controller operably coupled to the wireless transceiver to process the frames, wherein the controller is configured to, in response to an enablement of a low-latency preemption mode from another wireless device, transmit a request for a low-latency preemption, and then transmit a low-latency frame to the another wireless device.

In an embodiment, the another device is a transmission opportunity (TXOP) holder and wherein the controller is configured to transmit the low-latency frame during a TXOP of the TXOP holder.

In an embodiment, the low-latency preemption mode allows a transmission opportunity (TXOP) responder and/or a third party wireless device to do the low-latency preemption during a TXOP of the TXOP holder when a primary access category is a non-low-latency access category.

In an embodiment, the low-latency preemption is allowed after a frame exchange, after a Physical Layer Protocol Data Unit (PPDU) or after a responding frame of a transmission opportunity responder.

In an embodiment, the controller is configured to transmit the request for a low-latency preemption after an announcement of the low-latency preemption mode through a management frame by an access point.

In an embodiment, the controller is configured to receive a preemption disallowed indication from a particular wireless device when the particular wireless device intends to transmit the low-latency frame in a following frame exchange.

In an embodiment, the controller is configured to, in response to a frame from an access point that includes an indication for allowing a preemption request frame transmission in a transmission opportunity (TXOP), transmit a preemption request frame as the request for a low-latency preemption.

In an embodiment, the indication includes at least one of (a) the preemption request frame transmission is allowed a SIFS after the frame and (b), the preemption request frame transmission is allowed a SIFS after an immediate response frame for the frame.

In an embodiment, the controller is configured to obtain an information of a length of the immediate response frame by decoding a legacy signaling (L-SIG) field of a physical layer protocol data unit (PPDU) including an immediate response frame.

In an embodiment, the indication is included in a physical layer (PHY) header of the frame.

In an embodiment, the indication indicates whether a preemption request frame is allowed to be transmitted and an immediate response frame for the frame is to be transmitted by a recipient of the frame.

In an embodiment, a communications system comprises a first wireless device configured to transmit a frame that indicates an enablement of a low-latency preemption mode, and a second wireless device configured to receive frame, wherein the second wireless device is further configured to transmit a request for a low-latency preemption in response to the enablement of the low-latency preemption mode enable and then to transmit a low-latency frame to the first wireless device during a specified access period of the first wireless device.

In an embodiment, the first device is a transmission opportunity (TXOP) holder and wherein the second device is configured to transmit the low-latency frame during a TXOP of the TXOP holder.

In an embodiment, the low-latency preemption mode allows the second wireless device as a transmission opportunity (TXOP) responder and/or a non-TXOP responder to do the low-latency preemption during a TXOP of the first wireless device when a primary access category is a non-low-latency access category.

In an embodiment, the first wireless device is configured to transmit the frame after an announcement of the low-latency preemption mode through a management frame by an access point.

In an embodiment, the first wireless device is configured to transmit a preemption disallowed indication when the first wireless device intends to transmit a low-latency frame in a following frame exchange.

In an embodiment, the second wireless device is configured to, in response to a frame from an access point that includes an indication for allowing a preemption request frame transmission in a transmission opportunity (TXOP), transmit a preemption request frame as the request for a low-latency preemption.

In an embodiment, the indication includes at least one of (a) the preemption request frame transmission is allowed a SIFS after the frame and (b), the preemption request frame transmission is allowed a SIFS after an immediate response frame for the frame.

In an embodiment, the second wireless device is configured to obtain an information of a length of the immediate response frame by decoding a legacy signaling (L-SIG) field of a physical layer protocol data unit (PPDU) including an immediate response frame.

In an embodiment, a method comprises receiving, by a second wireless device, an enablement of a low-latency preemption mode from a first wireless device, transmitting, by the second wireless device, a request for a low-latency preemption to the first wireless device, and transmitting, by the second wireless device, a low-latency frame to the first wireless device during a specified access period of the first wireless device.

Other aspects in accordance with the invention will become apparent from the following detailed description, taken in conjunction with the accompanying drawings, illustrated by way of example of the principles of the invention.

### BRIEF DESCRIPTION OF DRAWINGS

FIG. 1 depicts a multi-link communications system for wireless communications that can be used in embodiments of the invention.

FIG. 2A illustrates a preemption in down-link (DL) transmission opportunity (TXOP) in accordance with prior art.

FIG. 2B illustrates an enhanced distribution channel access (EDCA)-based preemption in accordance with prior art.

FIG. 2C illustrates a preemption of DL TXOP to send up-link (UL) low-latency (LL) traffic in accordance with prior art.

FIG. 2D illustrates a preemption of UL TXOP to send DL LL traffic in accordance with prior art.

FIG. 3A illustrates a collision between a Preemption Request (PR) frame from a second station (STA2) and a block acknowledgement (BA) from a first station (STA1) when the PR frame is transmitted by a 3^{rd}-party LL station (STA) receiving a physical layer protocol data unit (PPDU) with the PR enabled without knowing the PPDU soliciting an immediate response frame.

FIG. 3B illustrates a collision between a PR frame from a third station (STA3) and a PR frame from a STA2 block acknowledgement (BA) from a first station (STA1) when a LL STA that is a hidden node from the intended recipient (e.g., a TXOP responder) of the PPDU does not detect or receive the immediate response frame.

FIG. 4 illustrates a first option for DL TXOP preemption where there is no immediate response frame after the PPDU indicating PR enabled (case #1), where an LL STA transmits a PR frame a SIFS after an PPDU (i.e., the PR frame transmitted after the SIFS following or subsequent to the PPDU) if the LL STA receives the PPDU including the PR Enabled field set to “01” (“Preemption Request is allowed (or enabled) in Short InterFrame Space (SIFS) after the PPDU”) in accordance with an embodiment of the invention.

FIG. 5 illustrates the first option for DL TXOP preemption where there is immediate response frame after the PPDU indicating PR enabled (case #2), where an LL STA transmits a PR frame a SIFS after an PPDU if the LL STA receives the PPDU indicating the PR Enabled field set to “10” (“Preemption Request is allowed (or enabled) a SIFS after the immediate response frame”) in accordance with an embodiment of the invention.

FIG. 6 illustrates the first option for UL TXOP preemption where there is no immediate response frame after the PPDU indicating PR enabled (case #3), where an LL STA transmits a PR frame a SIFS after an PPDU if the LL STA receives the PPDU indicating the PR Enabled field set to “01” in accordance with an embodiment of the invention.

FIG. 7 illustrates the first option for UL TXOP preemption where there is immediate response frame after the PPDU indicating PR enabled (case #4), where an LL STA transmits to an access point (AP) a PR frame a SIFS after an PPDU including the immediate response frame if the LL STA receives the PPDU including the PR Enabled field set to “10” in accordance with an embodiment of the invention.

FIG. 8 illustrates a second option for DL TXOP preemption where there is no immediate response frame after the PPDU indicating PR enabled (case #5), where an LL STA transmits a PR frame a SIFS after an PPDU if the LL STA receives the PPDU including the PR Enabled field set to “1” in accordance with an embodiment of the invention.

FIG. 9 illustrates the second option for DL TXOP preemption where there is immediate response frame after the PPDU indicating PR enabled (case #6), where an LL STA transmits a PR frame a SIFS after an PPDU including the immediate response frame if the LL STA receives the PPDU including the PR Enabled field set to “1” and the Response Indication (RI) field set to “1” in accordance with an embodiment of the invention.

FIG. 10 illustrates the second option for DL TXOP preemption where there is immediate response frame after the PPDU indicating PR enabled for a hidden LL STA from a TXOP holder (case #6-1), where an LL STA transmits a PR frame a SIFS after an PPDU including the immediate response frame if the LL STA receives the PPDU including the PR Enabled field set to “1” and the Response Indication (RI) field set to “1” in accordance with an embodiment of the invention.

FIG. 11 illustrates the second option for UL TXOP preemption where there is no immediate response frame after the PPDU indicating PR enabled (case #7), where an LL STA transmits a PR frame a SIFS after an PPDU if the LL STA receives the PPDU including the PR Enabled field set to “1” and the Response Indication (RI) field set to “0” in accordance with an embodiment of the invention.

FIG. 12 illustrates the second option for UL TXOP preemption where there is immediate response frame after the PPDU indicating PR enabled (case #8), where an LL STA transmits to an AP (TXOP responder) a PR frame a SIFS after an PPDU if the LL STA receives the PPDU including the PR Enabled field set to “1” and the Response Indication (RI) field set to “1” in accordance with an embodiment of the invention.

FIG. 13 illustrates a UL multi-user (MU) transmission (case #9), where the second option for UL TXOP preemption where there is immediate response frame after the PPDU indicating PR enabled (case #8), where an AP may transmit a Trigger frame (TF) to trigger UL trigger-based (TB) PPDU transmissions from one or more non-AP STAs in a TXOP in accordance with an embodiment of the invention.

FIG. 14 illustrates a DL MU transmission (case #10), where an AP may transmit a DL MU PPDU to more than one non-AP STAs in a TXOP in accordance with an embodiment of the invention.

FIG. 15A illustrates a preemption request indication included in a DL immediate response frame, where a PPDU including the low-latency traffic from an AP can include the preemption enabled field set to “0” in accordance with an embodiment of the invention.

FIG. 15B illustrates a preemption request indication included in a DL immediate response frame, where a PPDU including the low-latency traffic from an AP can include the preemption enabled field set to a non-zero value in accordance with an embodiment of the invention.

FIG. 16A illustrates a preemption request frame transmitted a SIFS after an immediate response frame (i.e., the preemption request frame transmitted after the SIFS following or subsequent to the immediate response frame), where a PPDU including the low-latency traffic from an AP can include the preemption enabled field set to “0” in accordance with an embodiment of the invention.

FIG. 16B illustrates a preemption request frame transmitted a SIFS after an immediate response frame, where a PPDU including the low-latency traffic from an AP can include the preemption enabled field set to a non-zero value in accordance with an embodiment of the invention.

FIG. 17A illustrates a preemption request frame transmitted a SIFS after an immediate response frame, where a PPDU including the low-latency traffic from an AP can include the preemption enabled field set to “0” in accordance with another embodiment of the invention.

FIG. 17B illustrates a preemption request frame transmitted a SIFS after an immediate response frame, where a PPDU including the low-latency traffic from an AP can include the preemption enabled field set to a non-zero value in accordance with another embodiment of the invention.

FIG. 18A illustrates a preemption request frame transmitted a SIFS after a UL PPDU with the preemption enabled field set to “1”, where a PPDU including the low-latency traffic from an AP can include the preemption enabled field set to “0” in accordance with an embodiment of the invention.

FIG. 18B illustrates a preemption request frame transmitted a SIFS after a UL PPDU with the preemption enabled field set to “1”, where a PPDU including the low-latency traffic from an AP can include the preemption enabled field set to a non-zero value in accordance with an embodiment of the invention.

FIG. 19 depicts a wireless device in accordance with an embodiment of the invention.

FIG. 20 illustrates a flow diagram of a in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

Several aspects of WiFi systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

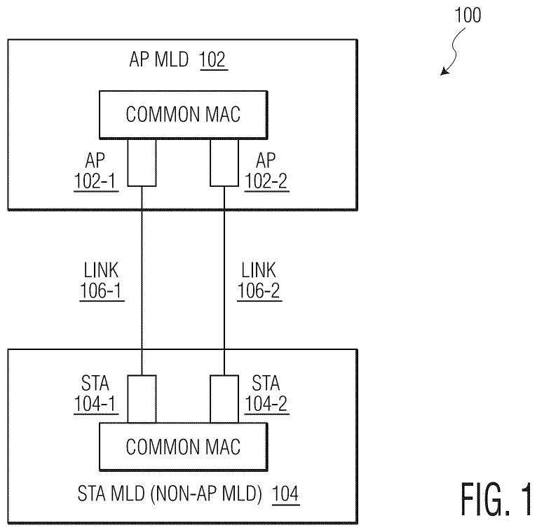

FIG. 1 depicts a multi-link communications system 100 for wireless (e.g., WiFi) communications that can be used in embodiments of the invention. In the embodiment depicted in FIG. 1, the multi-link communications system includes one access point (AP) multi-link device (MLD) 102, and one station (STA) MLD (non-AP MLD) 104. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Various iterations of the 802.11 specification are referred to herein. IEEE 802.11ac is referred to as very high throughput (VHT). IEEE 802.11ax is referred to as high efficiency (HE). IEEE 802.11be is referred to as extreme high throughput (EHT). IEEE 802.11bn is referred to as ultra-high reliability (UHR). The terms VHT, HE, EHT, and UHR may be used in the descriptions found herein.

Although the depicted multi-link communications system 100 is shown in FIG. 1 with certain components and described with certain functionality herein, other embodiments of the multi-link communications system may include fewer or more components to implement the same, less, or more functionality. For example, in some embodiments, the multi-link communications system includes a single AP MLD and multiple associated STA MLDs, or multiple AP MLDs and multiple STA MLDs with each STA MLD being associated with an AP MLD. In some embodiments, the legacy STAs (non-HE STAs) associate with one of the APs affiliated with the AP MLD. In some embodiments, an AP MLD may have a single affiliated AP. In some embodiments, a STA MLD may have a single affiliated STA. In another example, although the multi-link communications system is shown in FIG. 1 as being connected in a certain topology, the network topology of the multi-link communications system is not limited to the topology shown in FIG. 1.

In the embodiment depicted in FIG. 1, the AP MLD 102 includes two access points (APs) 102-1 and 102-2. In some embodiments, the AP MLD 102 implements upper layer Media Access Control (MAC) functionalities (e.g., association establishment, reordering of frames, etc.) and the APs 102-1 and 102-2 implement lower layer MAC functionalities (e.g., backoff, frame transmission, frame reception, etc.). The 102-1 and 102-2 may be implemented in hardware (e.g., circuits), software, firmware, or a combination thereof. The APs 102-1 and 102-2 may be fully or partially implemented as an integrated circuit (IC) device. In some embodiments, the APs 102-1 and 102-2 may be wireless APs compatible with at least one WLAN communications protocol (e.g., at least one IEEE 802.11 protocol). For example, the APs 102-1 and 102-2 may be wireless APs compatible with the IEEE 802.11bn protocol.

In some embodiments, an AP MLD 102 connects to a local area network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 102-1 and/or AP2 102-2) includes multiple RF chains. In some embodiments, an AP (e.g., AP1 102-1 and/or AP2 102-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 102-1 and 102-2 of the AP MLD 102 with multiple RF chains may operate in a different basic service set (BSS) operating channel (in a different link). For example, AP1 102-1 may operate in a 320 MHz BSS operating channel at 6 GHz band, and AP2 102-2 may operate in a 160 MHz BSS operating channel at 5 GHz band. Although the AP MLD 102 is shown in FIG. 1 as including two APs, other embodiments of the AP MLD 102 may include only one AP or more than two APs.

In the embodiment depicted in FIG. 1, the non-AP STA MLD 104 includes two non-AP STAs 104-1 and 104-2. The STAs 104-1 and 104-2 may be implemented in hardware (e.g., circuits), software, firmware, or a combination thereof. The STAs 104-1 and 104-2 may be fully or partially implemented as an IC device. In some embodiments, the STAs 104-1 and 104-2 are part of the STA MLD 104, such that the STA MLD may be a communications device that wirelessly connects to a wireless AP MLD. For example, the STA MLD 104 may be implemented in a laptop, a desktop personal computer (PC), a mobile phone, or other communications device that supports at least one WLAN communications protocol. In some embodiments, the non-AP STA MLD 104 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 104 implements a common MAC functionality and the non-AP STAs 104-1 and 104-2 implement a lower layer MAC data functionality.

In some embodiments, the AP MLD 102 and/or the STA MLD 104 may identify which communication links support multi-link operation during a multi-link operation setup phase and/or exchanges information regarding multi-link capabilities during the multi-link operation setup phase. In some embodiments, each of the non-AP STAs 104-1 and 104-2 of the STA MLD 104 may operate in a different frequency band. For example, the non-AP STA 104-1 in one link may operate in the 2.4 GHz frequency band and the non-AP STA 104-2 in another link may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 1, the STA MLD 104 communicates with the AP MLD 102 via two communication links 106-1 and 106-2. For example, each of the non-AP STAs 104-1 and 104-2 communicates with an AP 102-1 or 102-2 via a corresponding communication link 106-1 or 106-2. In an embodiment, a communication link (e.g., link 106-1 or link 106-2) may include a BSS operating channel established by an AP (e.g., AP 102-1 or AP 102-2) that features multiple 20 MHz channels used to transmit frames (e.g., Beacon frames, management frames, etc.) being carried in Physical Layer Convergence Protocol (PLCP) Protocol Data Units (PPDUs) between a first wireless device (e.g., an AP, an AP MLD, an STA, or an STA MLD) and a second wireless device (e.g., an AP, an AP MLD, an STA, or an STA MLD). In some embodiments, a 20 MHz channel may be a punctured 20 MHz channel or an unpunctured 20 MHz channel. Although the STA MLD 104 is shown in FIG. 1 as including two non-AP STAs, other embodiments of the STA MLD 13 may include one non-AP STA or more than two non-AP STAs. In addition, although the AP MLD 102 communicates (e.g., wirelessly communicates) with the STA MLD 104 via multiple links 106 and 106-2, in other embodiments, the AP MLD 102 may communicate (e.g., wirelessly communicate) with the STA MLD 104 via one communication link or more than two communication links.

In order to decrease the latency of low-latency traffic, the low-latency traffic frames can be transmitted in the following cases. In a transmission opportunity (TXOP) whose primary access category (AC) is for non-low-latency traffic, (1) the low-latency frames of the TXOP holder can be transmitted, (2) the low-latency frames of the TXOP responder can be transmitted if permitted by the TXOP holder or (3) the low-latency frames of the 3^{rd}-party STAs can be transmitted if permitted by the TXOP holder. As used herein, a 3^{rd}-party device means a device that is not a TXOP holder or a TXOP responder. A potential issue with such a scheme is that a STA may preempt the other STA's TXOP while the STA does not allow the other STAs to do the preemption in its TXOP. In addition, the implementation of the preemption of 3^{rd}-party STAs may be challenging since it is complicated.

In an embodiment (“option 1”), the following low-latency preemption modes are used to transmit low-latency traffic. In a first low-latency preemption mode (“mode 1”), using the indication in its PPDU, the TXOP responder is allowed by the TXOP holder to do the low-latency preemption in its TXOP with the primary AC being the non-low-latency AC, with the exception that if the TXOP holder intends to transmit its low-latency traffic frame in the next frame exchange, the PPDU of the current frame exchange will not allow the preemption. In a second low-latency preemption mode (“mode 2”), using the indication in its PPDU, the 3^{rd}-party STA/AP and the TXOP responder are allowed by the TXOP holder to do the low-latency preemption in its TXOP with primary AC being non-low-latency AC, with the exception that if the TXOP holder intends to transmit its low-latency traffic frame in the next frame exchange, the PPDU of the current frame exchange will not allow the preemption.

In an alternative embodiment (“option 2”), the following latency preemption modes are used to transmit low-latency traffic. In a first low-latency preemption mode (“mode 1.1”), the TXOP responder is allowed by the TXOP holder using the indication in its PPDU to do the low-latency preemption in its TXOP with the primary AC being the non-low-latency AC if the low-latency preemption is for the TXOP holder, with the exception that if the TXOP holder intends to transmit its low-latency traffic frame in the next frame exchange, the PPDU of the current frame exchange will not allow the preemption. In another first low-latency preemption mode (“mode 1.2”), the TXOP responder is allowed by the TXOP holder using the indication in its PPDU, to do the low-latency preemption in its TXOP with the primary AC being the non-low-latency AC if the low-latency preemption is for the TXOP holder or the 3^{rd}-party STA/AP with the exception that if the TXOP holder intends to transmit its low-latency traffic frame in the next frame exchange, the PPDU of the current frame exchange will not allow the preemption. In a second low-latency preemption mode (“mode 2), the 3^{rd}-party STA/AP and the TXOP responder are allowed by the TXOP holder using the indication in its PPDU to do the low-latency preemption in its TXOP with the primary AC being the non-low-latency AC with the exception that if the TXOP holder intends to transmit its low-latency traffic frame in the next frame exchange, the PPDU of the current frame exchange will not allow the preemption.

In some embodiments, in order to provide fair low-latency preemption, all the STAs in the basic service set (BSS) have the same view of low-latency access categories (ACs) and/or traffic identifies (TIDs) (ACs/TIDs) and non-low-latency ACs/TIDs. For example, the non-low-latency ACs/TIDs are defined as BSS policy, and an AP announces the non-low-latency ACs/TIDs in the BSS through Beacon or the other management frame. The low-latency ACs/TIDs are defined as BSS policy, and an AP announces the low-latency ACs/TIDs in the BSS through Beacon or the other management frame.

An AP/STA announces whether it supports the low-latency preemption and the supported low-latency preemption mode if it supports low-latency preemption. For example, an AP/STA announces one of the following: (1) the modes can be mode 1 and mode 2 in option 1 (described above) and (2) the modes can be mode 1.1, mode 1.2 and mode 2 in option 2 (described above). For modes defined in option 1, (a) if a STA announces the low-latency preemption mode 1, the STA needs to allow the TXOP responder to do the TXOP preemption in the STA's TXOP with primary AC being non-low-latency AC, and (b) if a STA announces the low-latency preemption mode 2, the STA needs to allow the TXOP responder and the 3^{rd}-party STAs to do the TXOP preemption in the STA's TXOP with primary AC being non-low-latency AC. For modes defined in option 2, (a) if a STA announces the low-latency preemption mode 1.1, the STA needs to allow the TXOP responder to do the TXOP preemption in the STA's TXOP with primary AC being non-low-latency AC if the low-latency preemption is for the STA, (b) if a STA announces the low-latency preemption mode 1.1, the STA needs to allow the TXOP responder to do the TXOP preemption in the STA's TXOP with primary AC being non-low-latency AC if the low-latency preemption is for the STA or the 3^{rd}-party STA/AP, and (c) if a STA announces the low-latency preemption mode 2, the STA needs to allow the TXOP responder and the 3^{rd}-party STAs to do the TXOP preemption in the STA's TXOP with primary AC being non-low-latency AC.

In some embodiments, the TXOP holder indicates the preemption type in its PHY header if the PPDU allows the low-latency preemption (LLP) after the PPDU or after the frame exchange that includes the frame in the PPDU. In a first example, the TXOP holder may indicate the preemption type as follows: (a) “000”-LLP disallowed after the PPDU and the responding PPDU, (b) “001”—mode 1.1 LLP allowed after the frame exchange, (c) “010”—mode 1.1 and 1.1 allowed after the frame exchange, (d) “011”—mode 2 and 1 allowed after the PPDU, and (e) “100”—mode 2 and 1 allowed after the TXOP responder's responding frame. In a second example, the TXOP holder may indicate the preemption type as follows: (a) “00”-LLP disallowed after the PPDU and the responding PPDU, (b) “01”—mode 1 LLP allowed after the frame exchange, (c) “010”—mode 2 and 1 allowed after the PPDU, (d) “11”—mode 2 and 1 allowed after the TXOP responder's responding frame. In a third example, the TXOP holder may indicate the preemption type as follows: (a) “00”-LLP disallowed after the PPDU and the responding PPDU, (b) “01”—mode 1 LLP allowed after the frame exchange, (c) “010”—mode 2 and 1 allowed after the PPDU. In the third example, the TXOP responder will not solicit the immediate responding frame in a PPDU that indicates LLP allowance.

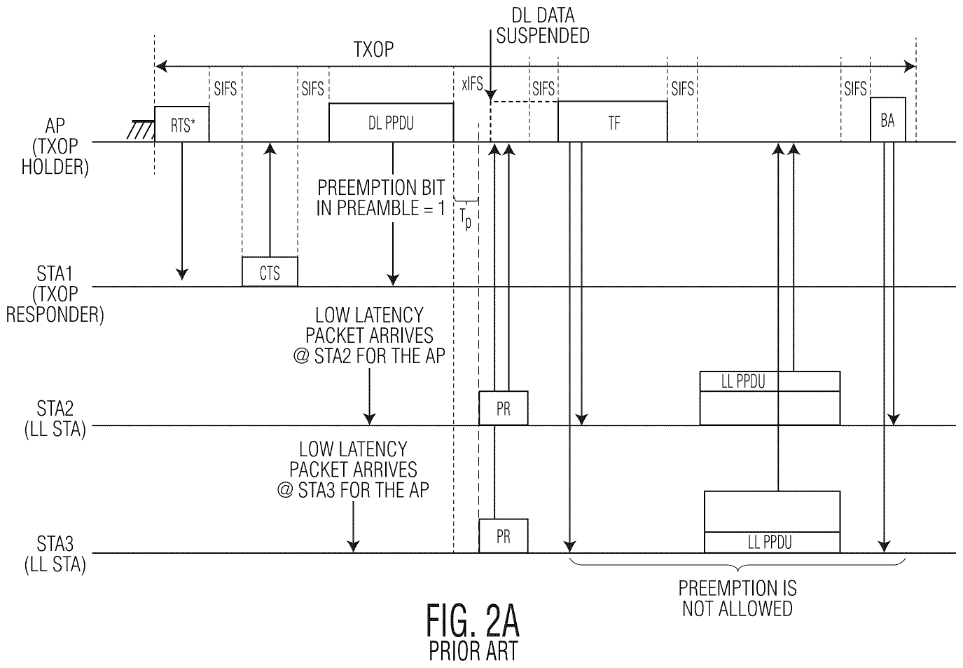

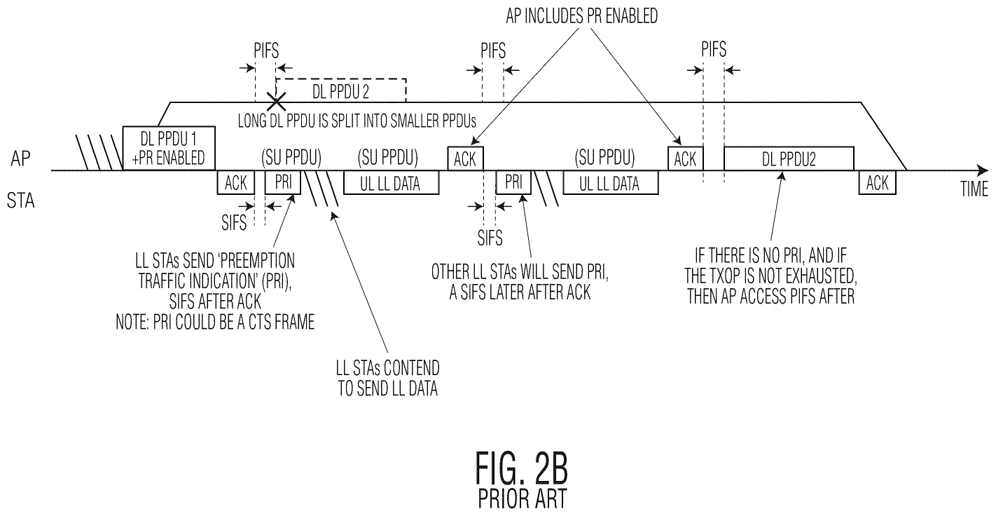

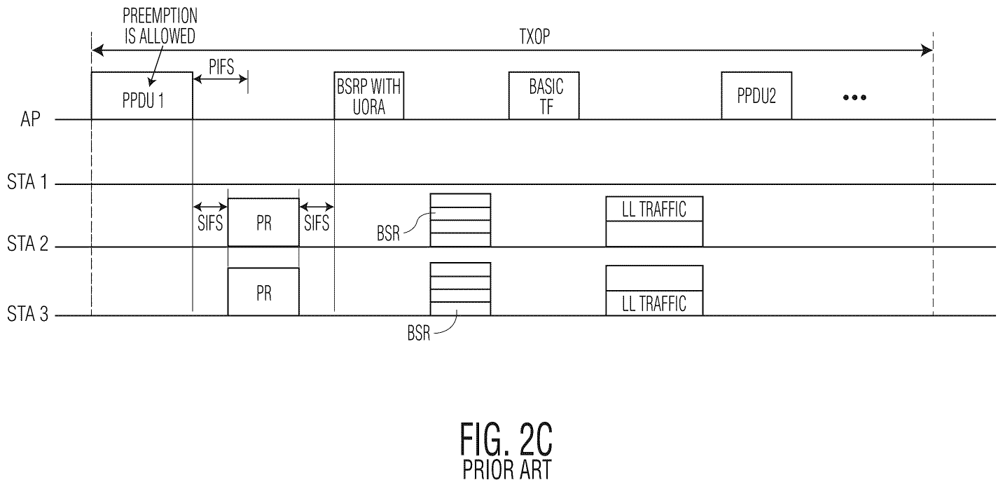

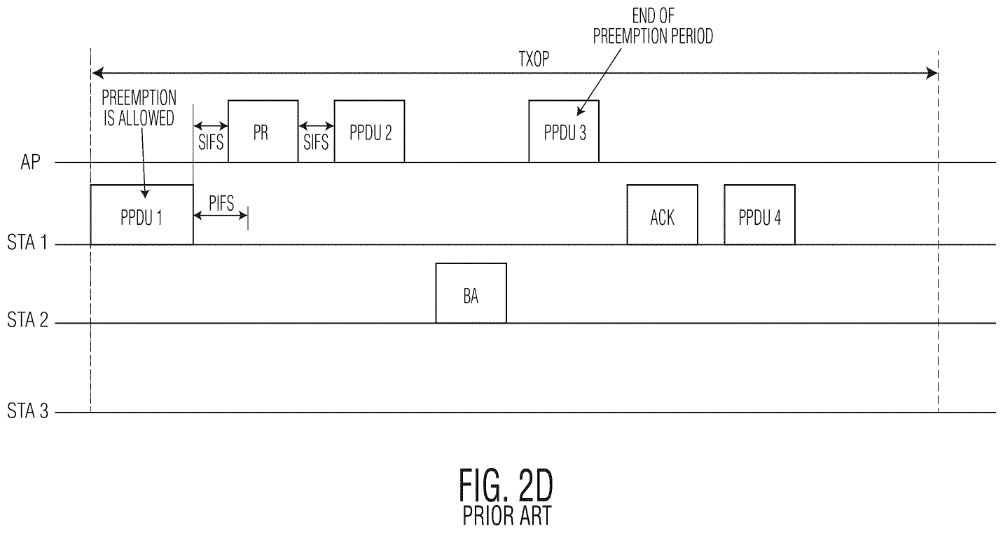

Preemption in down-link (DL) TXOP in accordance with prior art is now described with reference to FIG. 2A. For preemption in DL TXOP, a large PPDU (“DL PPDU” in FIG. 2A) is divided into small PPDUs with maximum length limitation and time gaps to enable preemption opportunity for low-latency (LL) transmitter. For this case, one or more LL transmitters can send common preemption request (PR) (similar to clear-to-send (CTS) frame) during the time gaps when the preemption is allowed. The time gap allowed for preemption is indicated in the PPDU preceding the time gap. Shorter x Inter-Frame Space (xIFS) (T_P) channel access may be used for the LL transmitter (T_P) to send common PR (T_P<T_g). A benefit is that this avoids reserving time slot periodically within TXOP for LL traffic. For this case, LL packet transmission may be initiated by the AP after the reception of the common PR. The AP can trigger the LL STAs to send LL packet by, for example, sending a Null Data Packet Feedback Report Poll (NFRP) or a Buffer Status Report Poll (BSRP) Trigger frame to get the LL buffer status report, and then triggering the LL data transmission. In FIG. 2A, PRs are received from the STA2 and the STA3 during a time gap between the xIFS and the next Short InterFrame Space (SIFS).

Enhanced distribution channel access (EDCA)-based preemption in accordance with prior art is now described with reference to FIG. 2B. For EDCA-based preemption, an AP grants low-latency (LL) devices an opportunity to contend within its DL TXOP. This handles the cases when the AP does not have the knowledge of which clients have LL traffic. The following are advantages of allowing EDCA explicitly by the AP: (a) it enables the AP to inject DL LL traffic that arrives during a DL TXOP; (b) the AP's announcement can be heard by all STAs in the BSS; and (c) it reduces contention with DL access for LL data. For this case, as illustrated in FIG. 2B, the AP sends a PR Enabled indication to LL clients, which could be sent in a PHY header of DL PPDU or block acknowledgement (BA) sent by the AP and may include the granted duration limit for the EDCA LL transmissions. Client, e.g., an STA, starts contending after the DL PPDU/BA by ignoring the network allocation vector (NAV) set by the AP in previous frames (e.g., AP uses multiple protection settings). The client uses only a random backoff count with to be determined (TBD) max time slots.

For preemption of DL TXOP to send uplink (UL) LL traffic in accordance with prior art is now described with reference to FIG. 2C. For preemption of DL TXOP to send UL LL traffic, an AP may transmit second PPDU (PPDU2) before transmitting a Buffer Status Report Poll (BSRP) if the LL traffic is carried in PPDU2. For this case, the AP must be able to solicit LL Buffer Status Report (BSR) from preempting STAs. A simple way for this requirement is to mandate uplink orthogonal frequency division multiple access random access (UORA) support for preempting STAs. In addition, when the AP sends BSRP frame with UORA, it is better only to allow BSR of LL traffic be reported by non-AP STAs, e.g., a new type of random-access RU for only LL traffic. Furthermore, the BSRP with UORA frame is optional to transmit. The AP may choose other ways to know which non-AP STAs are buffering LL traffic, e.g., use a NFRP Trigger frame or perform the prediction based on historical statistics.

For preemption of UL TXOP to send DL LL traffic in accordance with prior art in accordance with prior art is now described with reference to FIG. 2D. For preemption of UL TXOP to send DL LL, the TXOP holder will stop transmitting following the PPDU after receiving a PR frame. The contents of the PR frame from the AP and the non-AP STAs are same. A signaling in the third PPDU (PPDU3) informs the first station (STA1) continues to transmit a PPDU in the remaining TXOP. The detail of the signaling is to be determined (TBD), e.g., carried in the A-Control field.

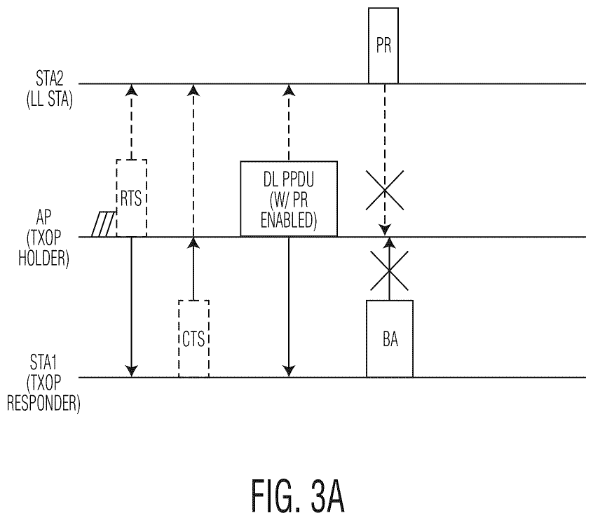

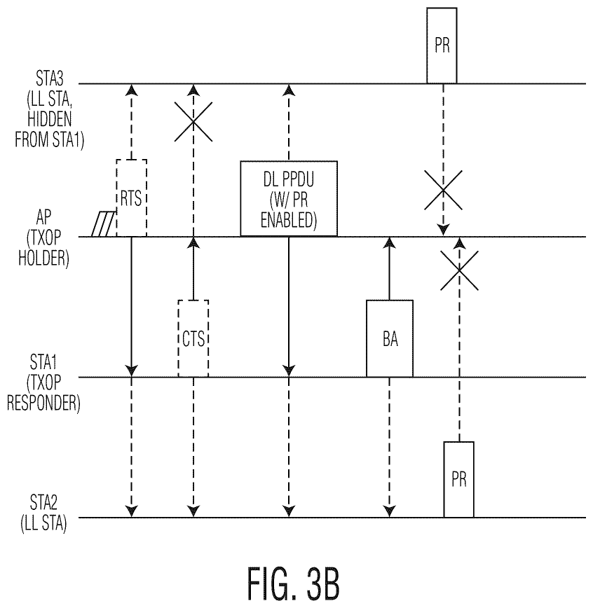

There are several issues with preemption. The first issue with preemption is when to transmit a Preemption Request frame. An immediate response frame (e.g., acknowledge (Ack) or BA frame) in response to a PPDU indicating “Preemption Request (PR) enabled” may or may not be transmitted depending on the Ack Policy of the MAC header in the MAC protocol Data Unit (MPDU) or Aggregated MPDU (A-MPDU) included in the PPDU. Indication of “PR enabled” can be included in the PHY header, so if a 3^{rd}-party LL STA may not successfully decode the MAC header of the (A-)MPDU included in the PPDU while decoding the PHY header of the PPDU, the 3^{rd}-party LL STA does not figure out whether the immediate response frame is transmitted right after the PPDU indicating the PR enabled. A PR frame transmitted by a 3^{rd}-party LL STA receiving the PPDU with the PR enabled without knowing the PPDU soliciting an immediate response frame may not be successfully received at the AP due to collision with the immediate response frame, as illustrated in FIG. 3A, which shows a collision between a PR frame from a second station (STA2) and a BA from a first station (STA1).

Even if the LL STA figures out the immediate response frame to be transmitted after the PPDU indicating “PR enabled”, the LL STA that is a hidden node from the intended recipient (e.g., a TXOP responder) of the PPDU does not detect or receive the immediate response frame. Then, the LL STA cannot transmit a PR frame right after the immediate response frame, which causes collision and PR reception failure at the AP, as illustrated in FIG. 3B, which shows a collision between a PR frame from a third station (STA3) and a PR frame from a STA2.

In an embodiment, PR frame transmission rule is established. When a TXOP holder or a TXOP responder includes an indication of “PR enabled” in a PHY header of a PPDU (e.g., UHR SIG field), the PR enabled indication includes additional indication for when a PR frame can be transmitted. For TXOP preemption, a PPDU includes an indication with at least one of the followings: (1) a PR frame transmission is not allowed after the PPDU; (2) a PR frame transmission is allowed a SIFS after the PPDU (i.e., allowed after the SIFS following or subsequent to the PPDU); or (3) a PR frame transmission is allowed a SIFS after the immediate response frame for the PPDU (i.e., allowed after the SIFS following or subsequent to the immediate response frame). For the indication, there are two options. The first option is that the indication can be included with a single field/subfield in the UHR SIG field of the UHR PPDU.

For example, in a Preemption Request (PR) Enabled field with the following values:
00: Preemption Request is disallowed (or disabled)
01: Preemption Request is allowed (or enabled) a SIFS after the PPDU
10: Preemption Request is allowed (or enabled) a SIFS after the immediate response frame
11: reserved

The second option is that the indication can be included with more than one fields/subfields in the UHR SIG field of the UHR PPDU. For example, the Preemption Request Enabled field and the Response Indication field can be used. The Preemption Request Enabled field can be used with the following values:
0: PR is disallowed (disabled)
1: PR is allowed (enabled)

The Response Indication (RI) field can be used with the following values:
0: The PPDU does not solicit an immediate response frame
1: The PPDU solicits an immediate response frame

For example, if an LL STA receives a PPDU including the PR Enabled field set to 1 and the RI field set to 0, an LL STA may transmit a PR frame a SIFS after the PPDU. If an LL STA receives a PPDU including the PR Enabled field set to 1 and the RI field set to 1, an LL STA may transmit a PR frame a SIFS after the immediate response frame for the PPDU. If an LL STA receives a PPDU including the PR Enabled field set to 0 and the RI field set to 0, an LL STA shall transmit a PR frame neither after the PPDU nor after the immediate response frame for the PPDU.

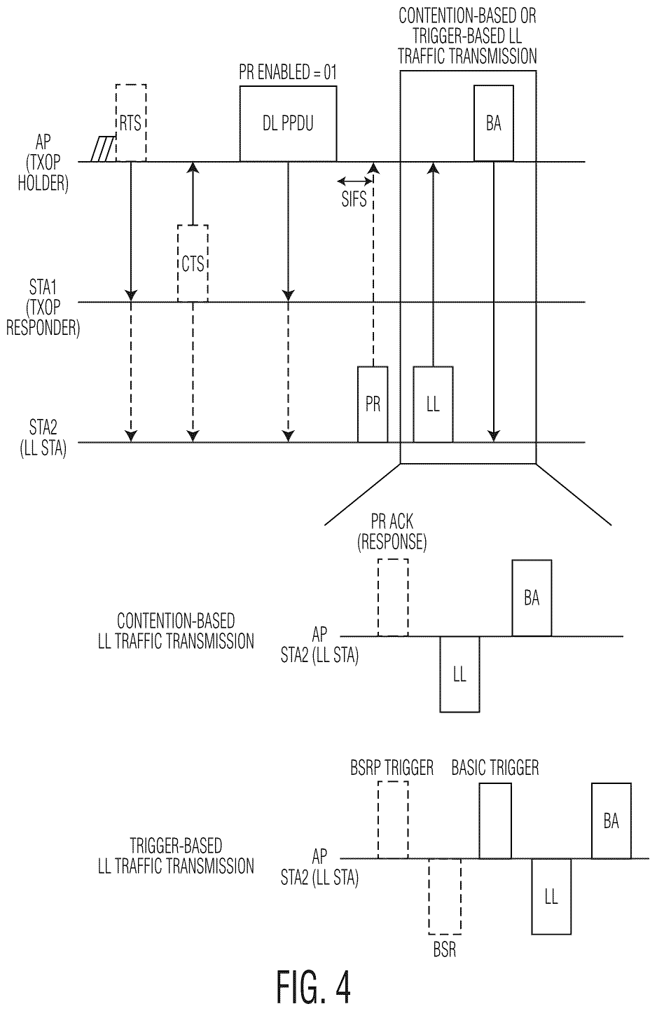

In the first option for DL TXOP preemption where there is no immediate response frame after the PPDU indicating PR enabled (case #1), if an LL STA receives a PPDU including the PR Enabled field set to “01” (“Preemption Request is allowed (or enabled) a SIFS after the PPDU”), the LL STA transmits a Preemption Request (PR) frame a SIFS after the PPDU, as illustrated in FIG. 4. After transmitting the PR frame, the LL STA may transmit the LL traffic using either the contention-based channel access (e.g., EDCA) or the trigger-based mechanism, as illustrated in FIG. 4.

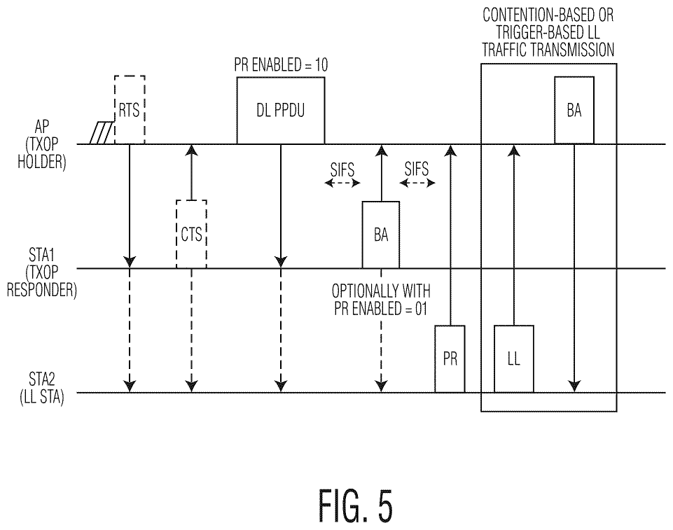

In the first option for DL TXOP preemption where there is immediate response frame after the PPDU indicating PR enabled (case #2), if an LL STA receives a PPDU indicating the PR Enabled field set to “10” (“Preemption Request is allowed (or enabled) a SIFS after the immediate response frame”), the LL STA transmits a PR frame a SIFS after the PPDU including the immediate response frame, as illustrated in FIG. 5. The PPDU length of the immediate response frame is indicated in the LENGTH field (and the RATE field) of the legacy signaling (L-SIG) field of the PPDU including the immediate response frame. The LL STA that decodes the L-SIG field of the PPDU including the immediate response frame followed by the PPDU with the PR Enabled field set to “10” may transmit the PR frame a SIFS after the PPDU including the immediate response frame. In another variant, the PPDU including the immediate response frame can be transmitted in a UHR PPDU and it can include the PR Enabled field set to “01”. An LL STA receiving the PPDU with the PR Enabled field set to “01” may transmit a PR frame a SIFS after the PPDU.

After transmitting the PR frame, the LL STA may transmit the LL traffic using either the contention-based channel access (e.g., EDCA) or the trigger-based mechanism, as illustrated in FIG. 5. If an LL STA does not obtain the PPDU length information of the immediate response frame (e.g., failure of decoding of the L-SIG of the PPDU including the immediate response frame), the LL STA does not transmit a PR frame after the PPDU indicating the PR Enabled field set to “10”.

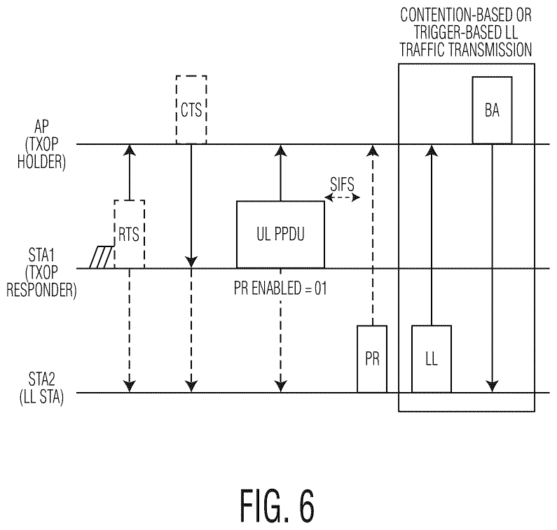

In the first option for UL TXOP preemption where there is no immediate response frame after the PPDU indicating PR enabled (case #3), a non-AP STA (TXOP holder) may transmit a UL PPDU indicating the PR Enabled field set to “01” to an AP (TXOP responder). If an LL STA receives a PPDU including the PR Enabled field set to “01”, the LL STA transmits a Preemption Request (PR) frame a SIFS after the PPDU. The LL STA can be a 3^{rd}-party non-AP STA or the AP, as illustrated in FIG. 6. After transmitting the PR frame, the LL STA may transmit the LL traffic, as illustrated in FIG. 6. The LL STA that is a non-AP STA may transmit LL traffic using either the contention-based channel access (e.g., EDCA) or the trigger-based mechanism. The LL STA that is an AP may transmit LL traffic after the PR frame without contention.

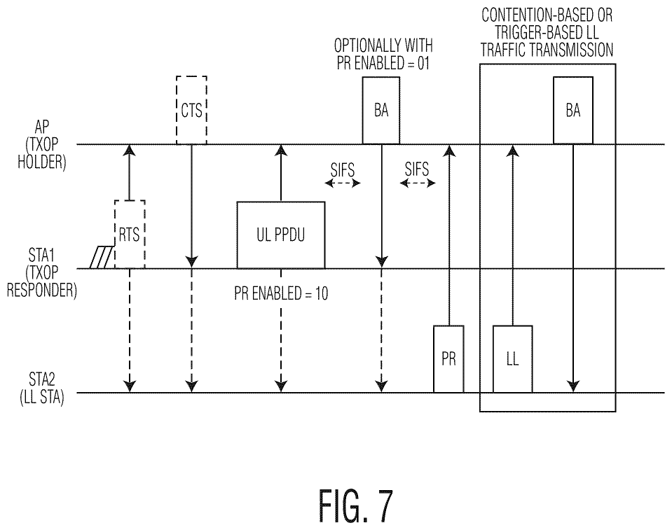

In the first option for UL TXOP preemption where there is immediate response frame after the PPDU indicating PR enabled (case #4), a non-AP STA (TXOP holder) may transmit a UL PPDU including the PR Enabled field set to “10” to an AP (TXOP responder). If an LL STA receives a PPDU including the PR Enabled field set to “10”, the LL STA transmits to the AP (TXOP responder) a Preemption Request (PR) frame a SIFS after the PPDU including the immediate response frame, as illustrated in FIG. 7. The PPDU length of the immediate response frame is indicated by the LENGTH field (and the RATE field) of the L-SIG field of the PPDU including the immediate response frame. The LL STA that decodes the L-SIG field of the PPDU including the immediate response frame followed by the PPDU (with the PR Enabled field set to 1 and the RI field set to 1) may transmit the PR frame a SIFS after the PPDU including the immediate response frame. If the immediate response frame is transmitted in a UHR PPDU, the PR Enabled field is included in the UHR PPDU. The PR Enabled field of the UHR PPDU can be set to “01” for the UHR PPDU. An LL STA that receives the UHR PPDU with the PR Enabled field set to “01”, regardless of receiving the UL PPDU including the PR Enabled field set to 10, may transmit a PR frame a SIFS after the PPDU. After transmitting the PR frame, the LL STA may transmit the LL traffic using either the contention-based channel access (e.g., EDCA) or the trigger-based mechanism, as illustrated in FIG. 7.

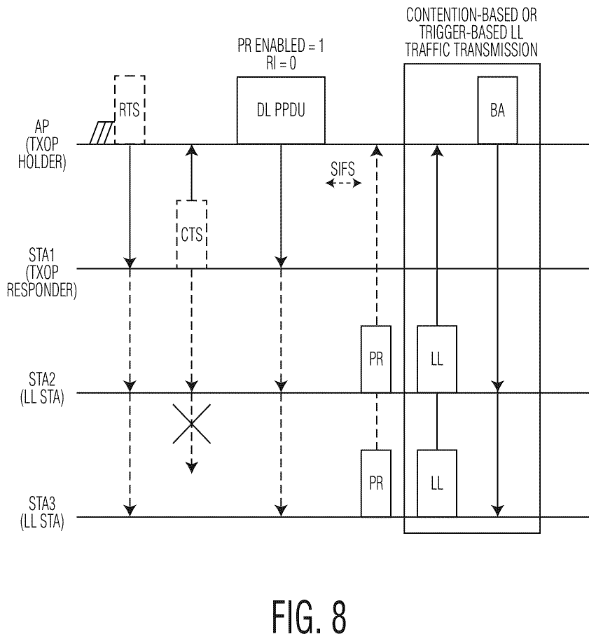

In the second option for DL TXOP preemption where there is no immediate response frame after the PPDU indicating PR enabled (case #5), if an LL STA receives a PPDU including the PR Enabled field set to “1” and the RI field set to “0”, the LL STA transmits a Preemption Request (PR) frame a SIFS after the PPDU, as illustrated in FIG. 8. After transmitting the PR frame, the LL STA may transmit the LL traffic using either the contention-based channel access (e.g., EDCA) or the trigger-based mechanism, as illustrated in FIG. 8.

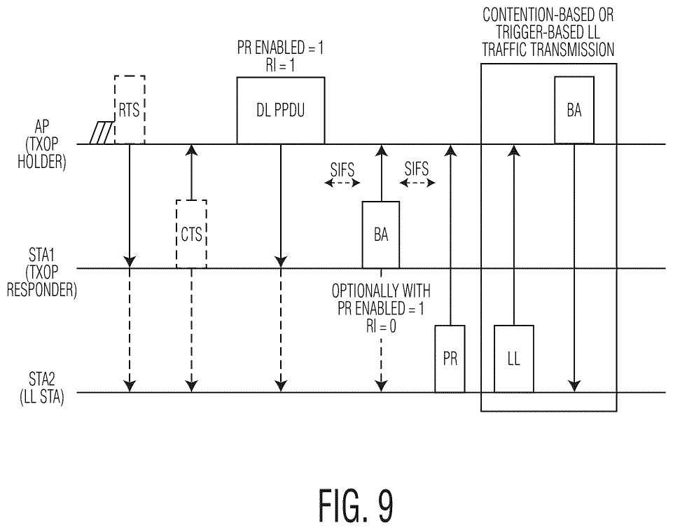

In the second option for DL TXOP preemption where there is immediate response frame after the PPDU indicating PR enabled (case #6), if an LL STA receives a PPDU indicating the PR Enabled field set to “1” and the RI field set to “1”, the LL STA transmits a PR frame a SIFS after the PPDU including the immediate response frame, as illustrated in FIG. 9. The PPDU length of the immediate response frame is indicated in the LENGTH field (and the RATE field) of the L-SIG field of the PPDU including the immediate response frame. The LL STA that decodes the L-SIG field of the PPDU including the immediate response frame followed by the PPDU (with the PR Enabled field set to “1” and the RI field set to “1”) may transmit the PR frame a SIFS after the PPDU including the immediate response frame. In another variant, the PPDU including the immediate response frame can be transmitted in a UHR PPDU and it can include the PR Enabled field set to “1” and the RI field set to “0”. An LL STA receiving the PPDU with the PR Enabled field set to “1” and the RI field set to “0” may transmit a PR frame a SIFS after the PPDU. After transmitting the PR frame, the LL STA may transmit the LL traffic using either the contention-based channel access (e.g., EDCA) or the trigger-based mechanism, as illustrated in FIG. 9. If an LL STA does receive or detect the PPDU of the immediate response frame, the LL STA does not transmit a PR frame after the PPDU indicating the PR Enabled field set to “1” and the RI field set to “1”. In this case, the LL STA does not obtain the PPDU length information of the immediate response frame (e.g., failure of decoding of the L-SIG of the PPDU including the immediate response frame) and/or the LL STA does not receive the PPDU with the PR Enabled field set to “1” and the RI field set to “0”.

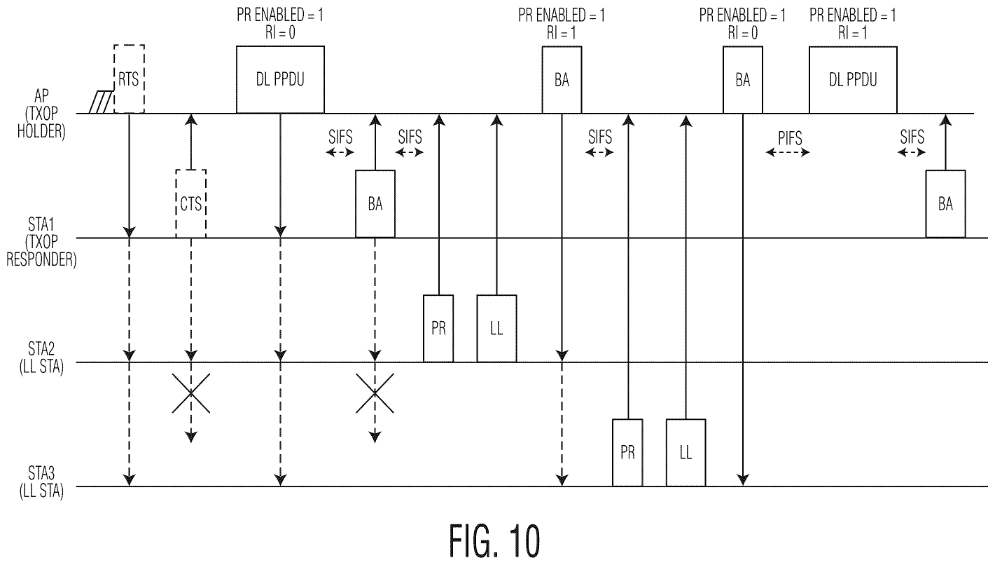

In the second option for DL TXOP preemption where there is immediate response frame after the PPDU indicating PR enabled for a hidden LL STA from a TXOP responder (case #6-1), if an LL STA receives a PPDU indicating the PR Enabled field set to “1” and the RI field set to “1”, the LL STA transmits a PR frame a SIFS after the PPDU including the immediate response frame, as illustrated in FIG. 10. After transmitting the PR frame, the LL STA may transmit the LL traffic using either the contention-based channel access (e.g., EDCA) or the trigger-based mechanism, as illustrated in FIG. 10. The AP may indicate the PR Enabled field equal to “1” and the RI field equal to “0” in the PPDU of the immediate response frame in response to the LL traffic. An LL STA that receives the PPDU with the PR Enabled field equal to “1” and the RI field equal to “0” may transmit a PR frame and transmit its LL traffic. If no PR frame is received, the AP may resume its DL transmission to one or more non-AP STA (TXOP responder).

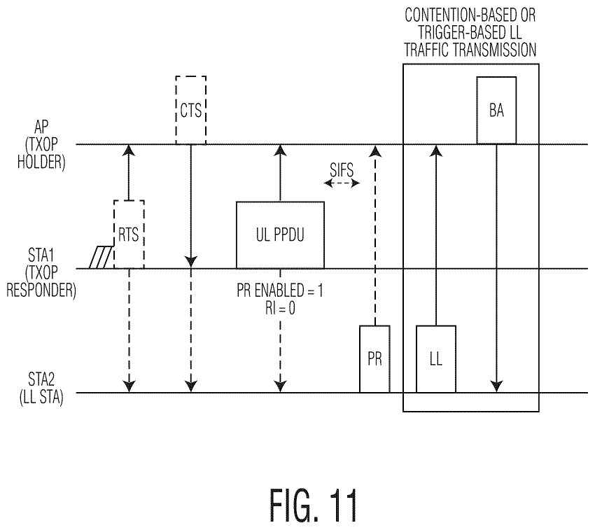

In the second option for UL TXOP preemption where there is no immediate response frame after the PPDU indicating PR enabled (case #7), a non-AP STA (TXOP holder) may transmit a UL PPDU indicating the PR Enabled field set to “1” and the RI field set to “0” to an AP (TXOP responder). If an LL STA receives a PPDU including the PR Enabled field equal to “1” and the RI field equal to “0”, the LL STA transmits a Preemption Request (PR) frame a SIFS after the PPDU, as illustrated in FIG. 11. The LL STA can be a 3^{rd}-party non-AP STA or the AP. After transmitting the PR frame, the LL STA may transmit the LL traffic, as illustrated in FIG. 11. An LL non-AP STA may transmit LL traffic using either the contention-based channel access (e.g., EDCA) or the trigger-based mechanism. The LL AP may transmit LL traffic after the PR frame without contention.

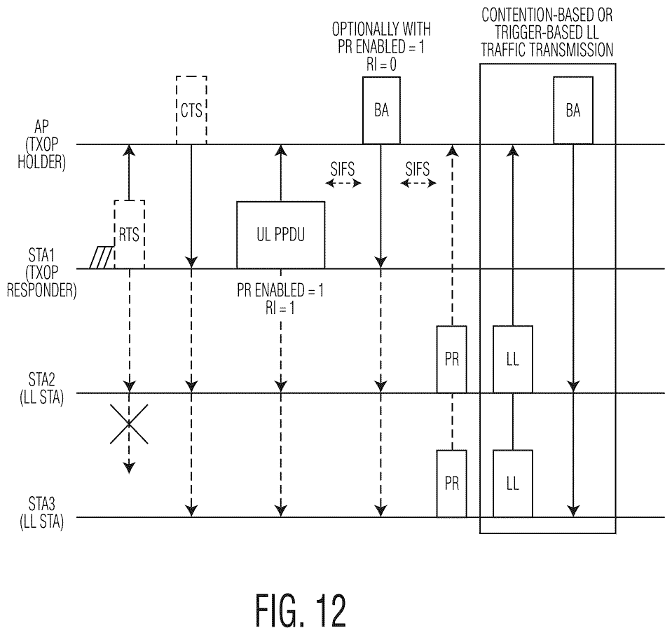

In the second option for UL TXOP preemption where there is immediate response frame after the PPDU indicating PR enabled (case #8), a non-AP STA (TXOP holder) may transmit a UL PPDU including the PR Enabled field set to “10” to an AP (TXOP responder). If an LL STA receives a PPDU including the PR Enabled field set to “1” and the RI field set to “1”, the LL STA transmits to the AP (TXOP responder) a Preemption Request (PR) frame a SIFS after the PPDU including the immediate response frame, as illustrated in FIG. 12. The PPDU length of the immediate response frame is indicated by the LENGTH field (and the RATE field) of the L-SIG field of the PPDU including the immediate response frame. The LL STA that decodes the L-SIG field of the PPDU including the immediate response frame followed by the PPDU (with the PR Enabled field set to “1” and the RI field set to “1”) may transmit the PR frame a SIFS after the PPDU including the immediate response frame. If the immediate response frame is transmitted in a UHR PPDU, the PR Enabled field and the RI field are included. The PR Enabled field equal to “1” and the RI field equal to “0” can be indicated for the UHR PPDU. An LL STA that receives the UHR PPDU with the PR Enabled field equal to “1” and the RI field equal to “0”, regardless of receiving the UL PPDU including the PR Enabled field equal to “1” and the RI field equal to “1”, may transmit a PR frame a SIFS after the PPDU. After transmitting the PR frame, the LL STA may transmit the LL traffic using either the contention-based channel access (e.g., EDCA) or the trigger-based mechanism, as illustrated in FIG. 12.

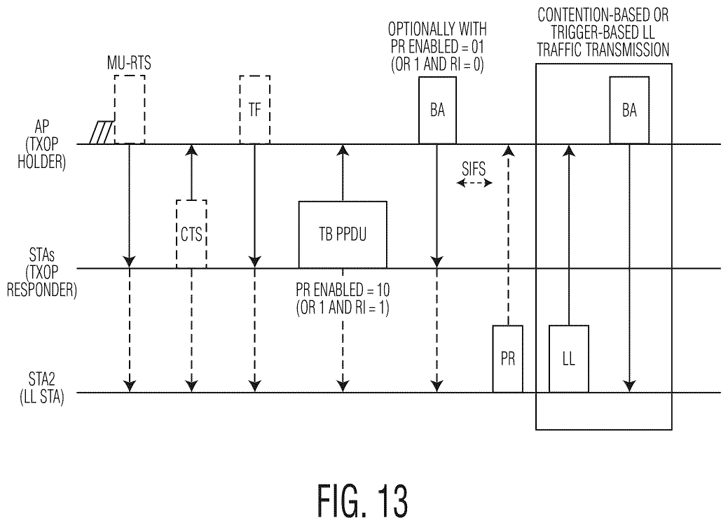

For UL multi-user (MU) transmission (case #9), an AP may transmit a Trigger frame (TF) to trigger UL trigger-based (TB) PPDU transmissions from one or more non-AP STAs in a TXOP, as illustrated in FIG. 13. If the Trigger frame is transmitted in a UHR PPDU, the PR Enabled field can be set to “0” in the PHY header of the UHR PPDU. The Common Info field of the Trigger frame can include the value(s) of the PR Enabled field (and the RI field) to be set in the PHY header of the response frame (e.g., TB PPDU). The value of the PR Enabled field can be set to “10” for option 1 (i.e., the first option), or “1” for option 2 (i.e., the second option). The value of the RI field can be set to “1” for option 2. Non-AP STA(s) may transmit TB PPDU(s) in response to the Trigger frame that includes the PR Enabled set to “10” for option 1 (or the PR Enabled set to “1” and the RI field set to “1” for option 2) in the PHY header of the TB PPDU(s). In response to the TB PPDU(s), the AP may transmit an immediate response frame (e.g., Multi-STA BA (M-BA)). If the immediate response frame is transmitted in a UHR PPDU, the PR Enabled field is set to “01” for option 1 (or the PR Enabled field is set to “1” and the RI field is set to “0” for option 2). If an LL STA receives the TB PPDU indicating the PR Enabled field set to “10” (or set to “1” and the RI field set to “1”), the LL STA transmits a PR frame a SIFS after the PPDU including the immediate response frame (e.g., M-BA), as illustrated in FIG. 13. After transmitting the PR frame, the LL STA may transmit the LL traffic using either the contention-based channel access (e.g., EDCA) or the trigger-based mechanism, as illustrated in FIG. 13.

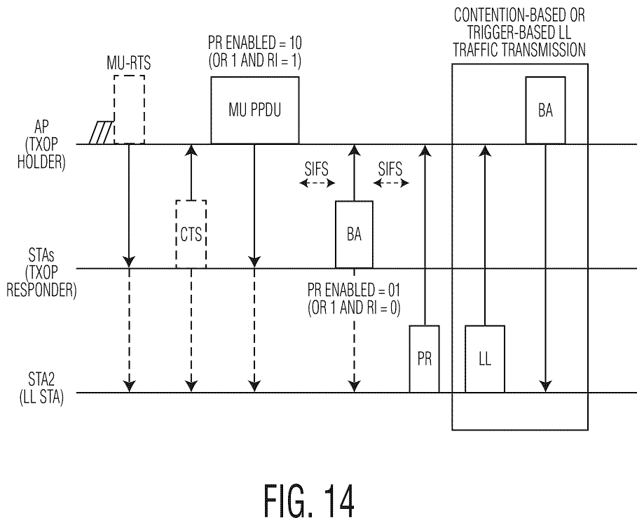

For DL MU transmission (case #10), an AP may transmit a DL MU PPDU to more than one non-AP STAs in a TXOP, as illustrated in FIG. 14. The PR Enabled field can be set to “10” (or set to “1” and the RI field set to “1”) in the PHY header of the DL MU PPDU. A Trigger frame can be aggregated in an A-MPDU included in the DL MU PPDU to solicit an immediate response frame from the recipient of the DL MU PPDU. The Trigger frame can include the value(s) of the PR Enabled field (and the RI field) to be set in the PHY header of the response frame (e.g., BA in a TB PPDU). The value of the PR Enabled field can be set to “10” for option 1, or “1” for option 2. The value of the RI field can be set to “1” for option 2. A non-AP STA may transmit an immediate response frame (e.g., BA) in a TB PPDU in response to the DL MU PPDU that includes the PR Enabled set to “01” (or set to “1” and the RI field set to “0”) in the PHY header of the TB PPDU. If an LL STA receives the DL MU PPDU indicating the PR Enabled field set to “10” (or set to 1 and the RI field set to 1), the LL STA transmits a PR frame a SIFS after the PPDU including the immediate response frame (e.g., BA in the TB PPDU), as illustrated in FIG. 14. After transmitting the PR frame, the LL STA may transmit the LL traffic using either the contention-based channel access (e.g., EDCA) or the trigger-based mechanism, as illustrated in FIG. 14.

The second issue with preemption is who can transmit a Preemption Request frame. Low-latency traffic has a delay bound requirement of which the traffic needs to be delivered within a certain time interval. TXOP preemption is used for a STA to transmit a low-latency traffic during other's TXOP under the TXOP holder's permission in order not to exceed the delay bound for the traffic transmission. A clear rule and criteria for TXOP preemption need be defined not to abuse the TXOP preemption by a greedy STA and to provide the fair opportunities to the STAs while meeting the delay bound requirement for the low-latency traffic transmission. The delay bound can specify the maximum amount of time, for example, in microseconds, targeted to transport a MAC service data unit (MSDU) or aggregated-MSDU (A-MSDU) belonging to the traffic flow, measured between the time marking the arrival of the MSDU, or the first MSDU of the MSDUs constituting an A-MSDU, at the local MAC sublayer from the local MAC service access point (SAP) and the time of completion of the successful (re)transmission of the MPDU containing the MSDU to the destination.

In an embodiment, a delay-bound counter (DC) is used to count the time to the target transmission time of low-latency traffic. TXOP preemption is enabled for an LL STA (e.g., enabling preemption request frame transmission) when the delay-bound counter of the low-latency data reaches a predefined value. The predefined value can be announced by an AP using a broadcast management frame (e.g., Beacon, Probe Response, etc.). The predefined value can be provided in an individually addressed management/action frame (e.g., Association Response, Stream Classification Service (SCS) Request/Response, etc.).

As an example, a STA maintains a delay-bound counter (DC) for the data pending for transmission in the queue. When a data is enqueued, the delay-bound counter starts counting down the remaining time for transmission. The initial values of the delay-bound counter are set according to the time for low-latency traffic to be delivered by the delay bound. If DC<TBD value, the STA may transmit a preemption request frame to an AP after receiving a PPDU indicating preemption to be allowed in other STA's TXOP.

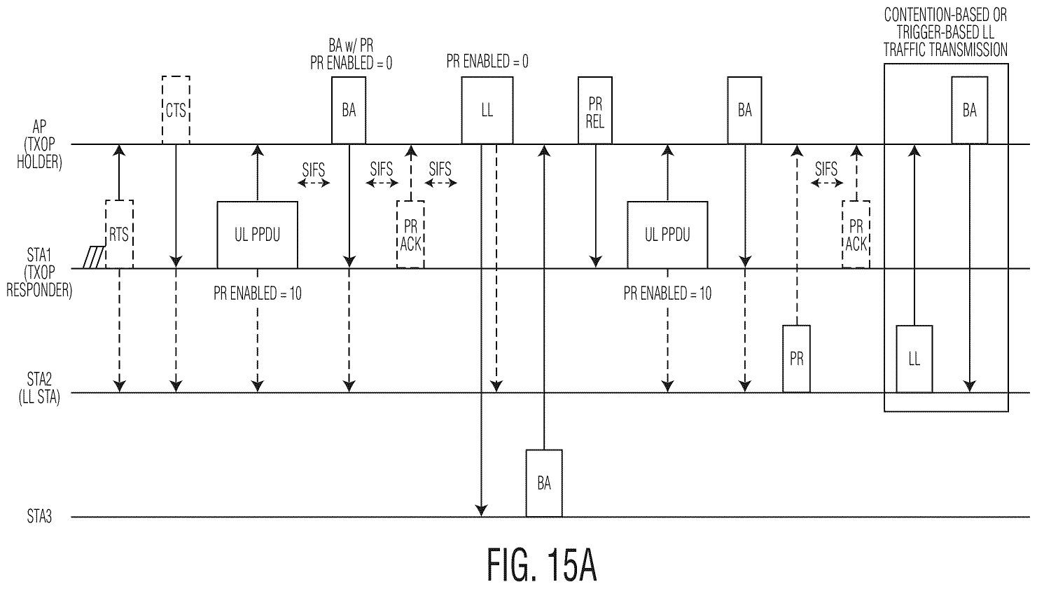

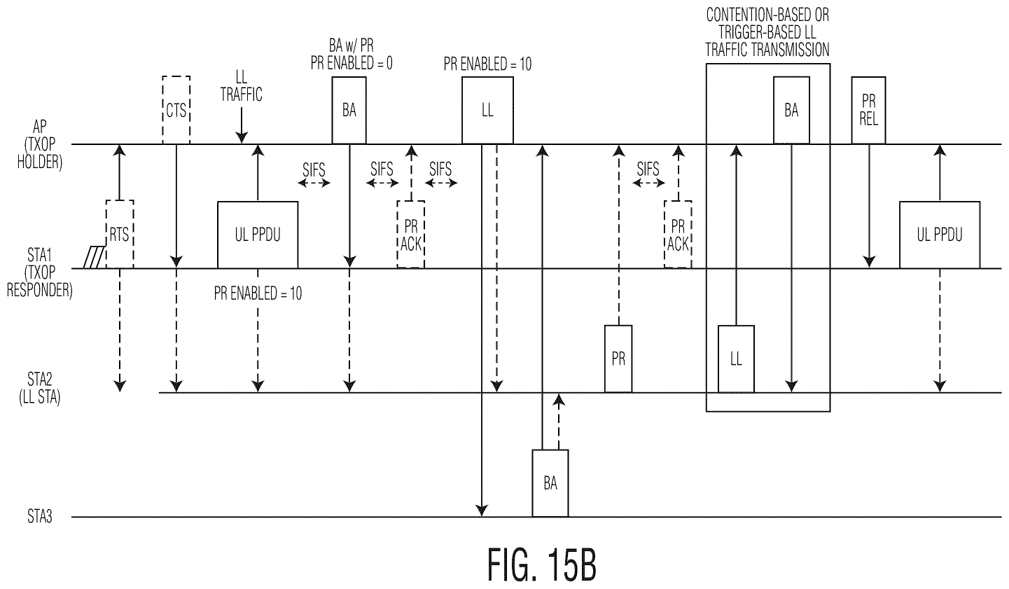

An AP that is a TXOP responder may include a preemption request indication in a DL immediate response frame when the following conditions are met: (1) the AP has low-latency traffic to transmit; (2) the TXOP holder transmits an UL PPDU including the preemption enabled indication; (3) the UL PPDU solicits an immediate response frame; and (4) the preemption enabled indication indicates that preemption request frame transmission is allowed a SIFS after the immediate response frame. The immediate response frame including the preemption request indication can include the preemption enabled indication field set to “0” (e.g., preemption request frame transmission (tx) is not allowed after the PPDU) to prevent a 3^{rd}-party non-AP STA transmitting a preemption request frame after the immediate response frame. The TXOP holder receiving the preemption request in the immediate response frame may transmit a preemption request acknowledgement frame. The AP can transmit the low-latency traffic a SIFS after the immediate response frame including the preemption request indication (or a SIFS after the preemption request acknowledgement frame). A PPDU including the low-latency traffic can include the preemption enabled field set to “0” (as illustrated in an example shown in FIG. 15A) or a non-zero value (as illustrated in an example shown in FIG. 15B). A 3^{rd}-party non-AP STA may transmit a preemption request frame and low-latency traffic when it receives a DL frame with the preemption enabled field set to a non-zero value. The AP can transmit a frame indicating the preemption release to the TXOP holder after finishing its low-latency traffic transmission.

An AP that is a TXOP responder may transmit a preemption request frame a SIFS after an immediate response frame when the following conditions are met. The AP has low-latency traffic to transmit. The TXOP holder transmits an UL PPDU including the preemption enabled indication, which may solicit an immediate response frame. The preemption enabled indication indicates that preemption request frame transmission is allowed a SIFS after the immediate response frame.

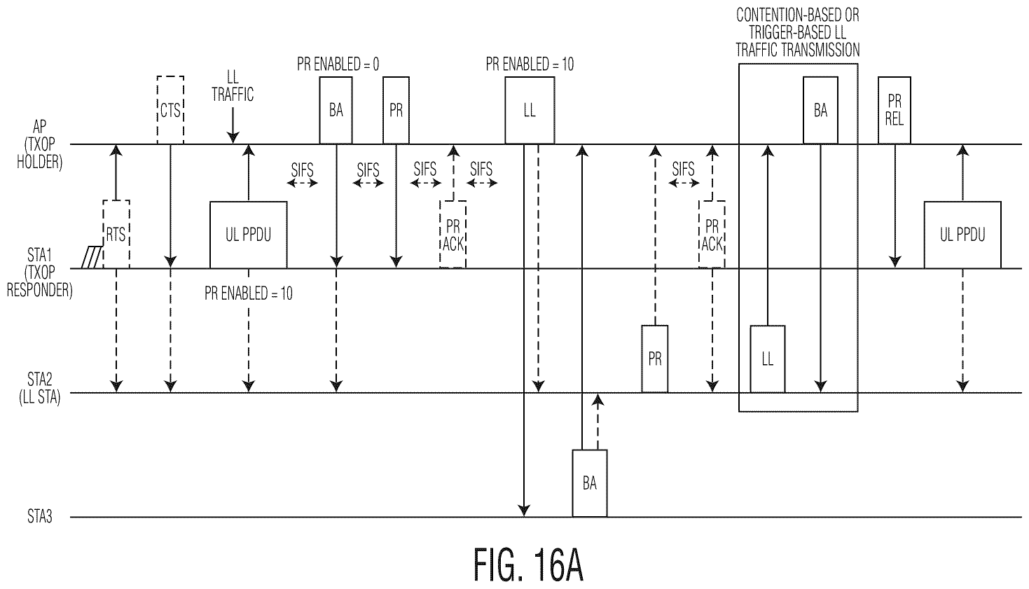

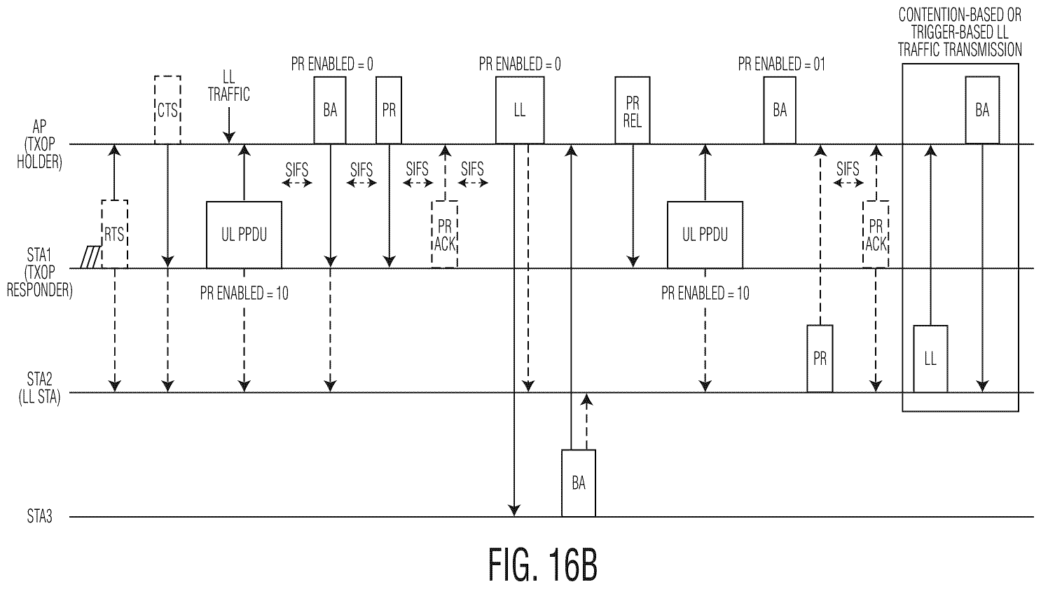

The immediate response frame can include the preemption enabled indication field set to “0” (e.g., preemption request frame transmission is not allowed after the PPDU) to prevent 3^{rd}-party non-AP STA transmitting a preemption request frame after the immediate response frame. The TXOP holder receiving the preemption request frame may transmit a preemption request acknowledgement frame. The AP can transmit a DL frame including the low-latency traffic a SIFS after the preemption request frame (or a SIFS after the preemption request acknowledgement frame). A PPDU including the low-latency traffic can include the preemption enabled field set to “0” (as illustrated in an example shown in FIG. 16A) or a non-zero value (e (as illustrated in an example shown in FIG. 16B). A 3^{rd}-party non-AP STA may transmit a preemption request frame and low-latency traffic when it receives DL frame with the preemption enabled field set to a non-zero value. The AP can transmit a frame indicating the preemption release to the TXOP holder after finishing its low-latency traffic transmission.

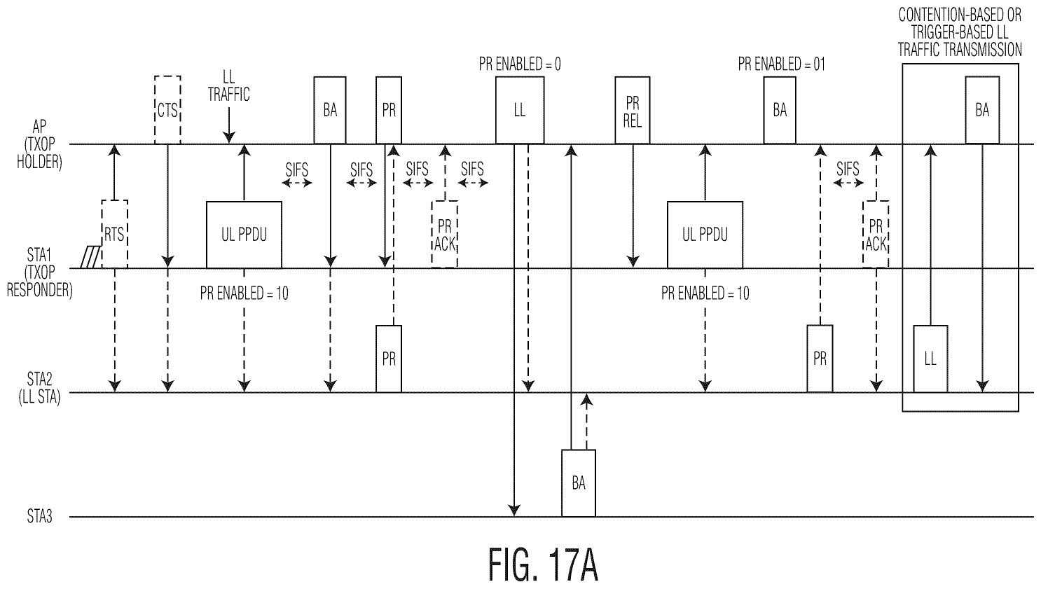

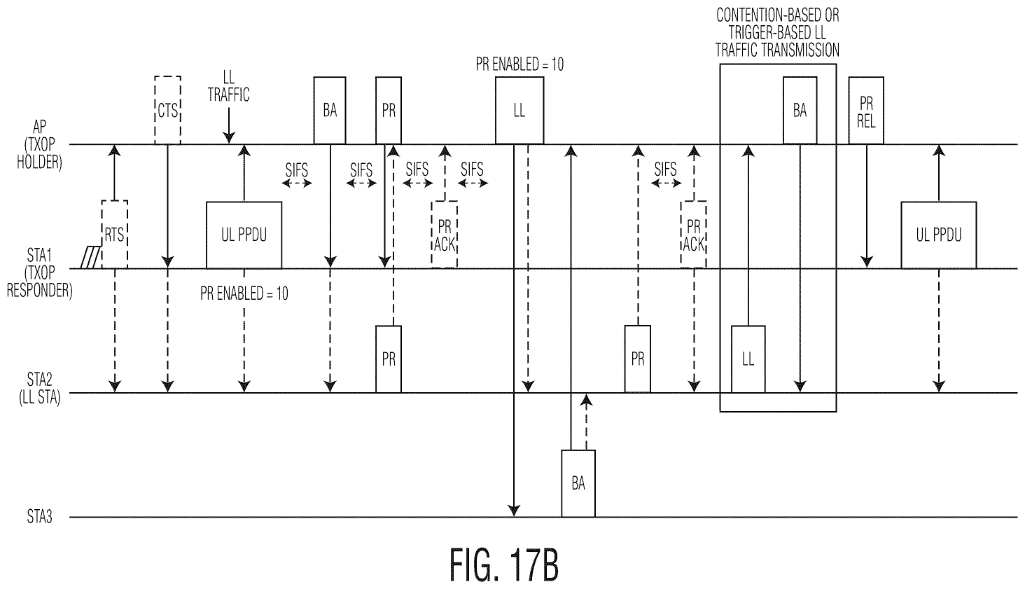

An AP that is a TXOP responder may transmit a preemption request frame a SIFS after an immediate response frame when the following conditions are met. The AP has low-latency traffic to transmit. The TXOP holder transmits an UL PPDU including the preemption enabled indication, which may solicit an immediate response frame. The preemption enabled indication indicates that preemption request frame transmission is allowed a SIFS after the immediate response frame. The TXOP holder receiving the preemption request frame may transmit a preemption request acknowledgement frame. The AP can transmit a DL frame including the low-latency traffic a SIFS after the preemption request frame (or SIFS after the preemption request acknowledgement frame). A PPDU including the low-latency traffic can include the preemption enabled field set to “0” (as illustrated in an example shown in FIG. 17A) or a non-zero value (as illustrated in an example shown in FIG. 17B). A 3^{rd}-party non-AP STA may transmit a preemption request frame and low-latency traffic when it receives DL frame with the preemption enabled field set to a non-zero value. The AP can transmit a frame indicating the preemption release to the TXOP holder after finishing its low-latency traffic transmission.

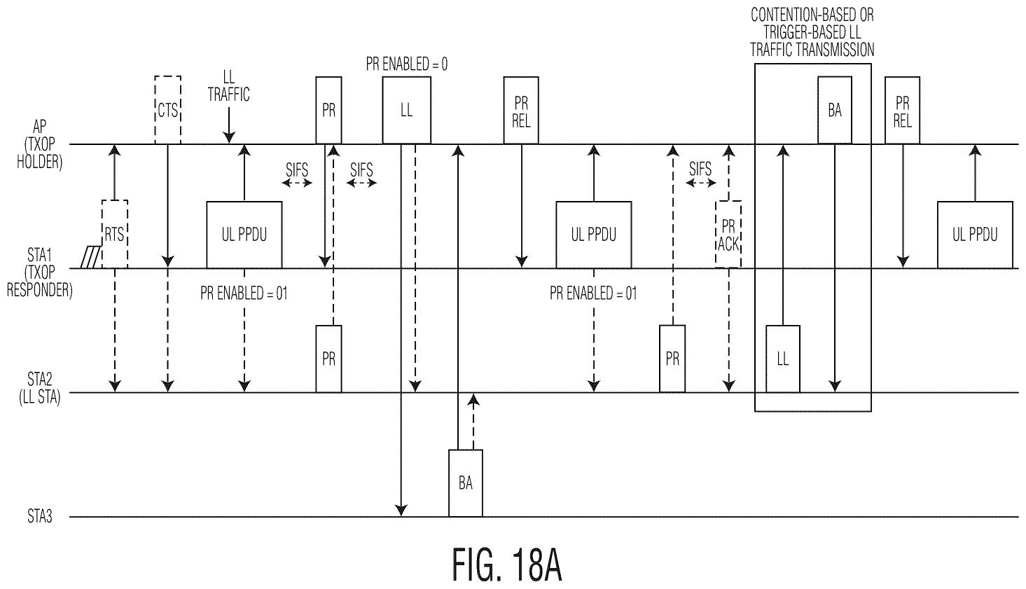

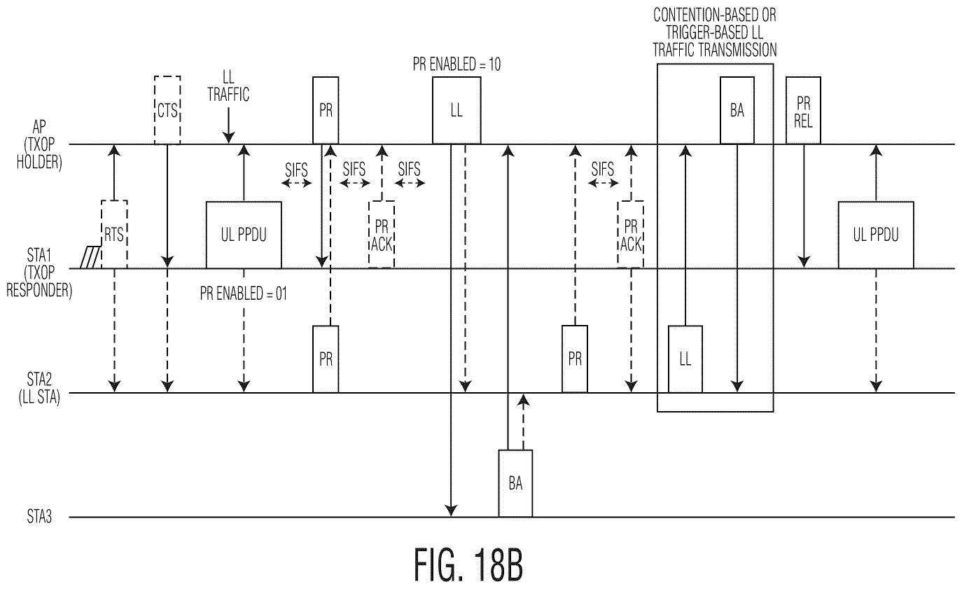

An AP that is a TXOP responder may transmit a preemption request frame a SIFS after an UL PPDU when the following conditions are met. The AP has low-latency traffic to transmit. The UL PPDU includes the indication of that preemption request frame transmission is allowed a SIFS after the PPDU. The TXOP holder receiving the preemption request frame may transmit a preemption request acknowledgement frame. The AP can transmit a DL frame including the low-latency traffic a SIFS after the preemption request frame (or a SIFS after the preemption request acknowledgement frame). A PPDU including the low-latency traffic can include the preemption enabled field set to “0” (as illustrated in an example shown in FIG. 18A) or a non-zero value ((as illustrated in an example shown in FIG. 18B). A 3^{rd}-party non-AP STA may transmit a preemption request frame and low-latency traffic when it receives DL frame with the preemption enabled field set to a non-zero value. The AP can transmit a frame indicating the preemption release to the TXOP holder after finishing its low-latency traffic transmission.

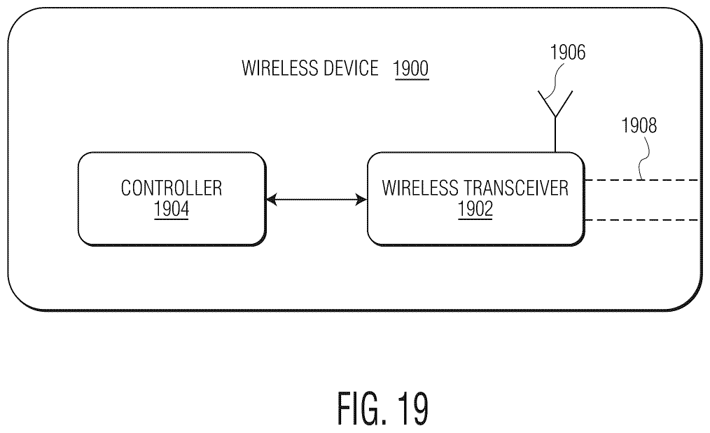

FIG. 19 depicts a wireless device 1900 in accordance with an embodiment of the invention. The wireless device 1900 can be used in the multi-link communications system 100 depicted in FIG. 1. For example, the wireless device 1900 may be an embodiment of the AP MLD 102 or the non-AP STA MLD 104 depicted in FIG. 1.

In the embodiment depicted in FIG. 19, the wireless device 1900 includes a wireless transceiver 1902, a controller 1904 operably connected to the wireless transceiver, and at least one antenna 1906 operably connected to the wireless transceiver. In some embodiments, the wireless device 1900 may include at least one optional network port 1908 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 1900 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a DSP, or a CPU. The antenna may be any suitable type of antenna. For example, the antenna may be an induction type antenna such as a loop antenna or any other suitable type of induction type antenna. However, the antenna is not limited to an induction type antenna. The network port may be any suitable type of port.

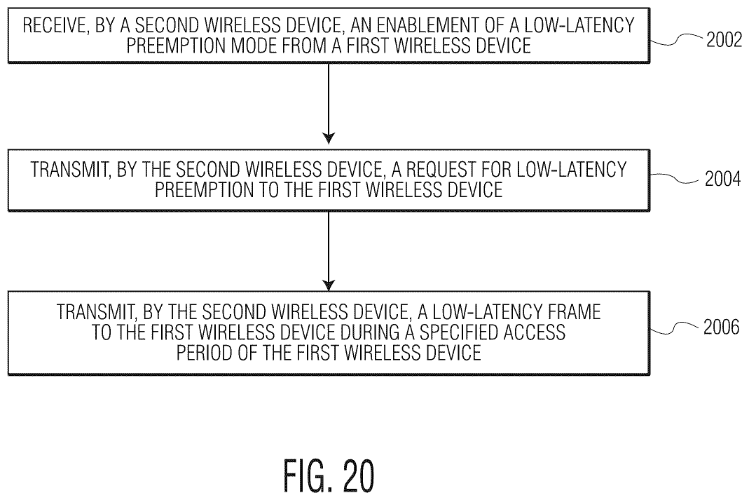

A method in accordance with an embodiment of the invention is described with reference to a flow diagram of FIG. 20. At block 2002, an enablement of a low-latency preemption mode from a first wireless device is received by a second wireless device. At block 2004, a request for a low-latency preemption to the first wireless device is transmitted by the second wireless device. At block 2006, a low-latency frame to the first wireless device is transmitted by the second wireless device during a specified access period of the first wireless device

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A wireless device comprising:
a wireless transceiver to receive and transmit frames; and
a controller operably coupled to the wireless transceiver to process the frames, wherein the controller is configured to, in response to an enablement of a low-latency preemption mode from another wireless device, transmit a request for a low-latency preemption, and then transmit a low-latency frame to the another wireless device.

2. The wireless device of claim 1, wherein the another device is a transmission opportunity (TXOP) holder and wherein the controller is configured to transmit the low-latency frame during a TXOP of the TXOP holder.

3. The wireless device of claim 1, wherein the low-latency preemption mode allows a transmission opportunity (TXOP) responder and/or a third party wireless device to do the low-latency preemption during a TXOP of the TXOP holder when a primary access category is a non-low-latency access category.

4. The wireless device of claim 3, wherein the low-latency preemption is allowed after a frame exchange, after a Physical Layer Protocol Data Unit (PPDU) or after a responding frame of a transmission opportunity responder.

5. The wireless device of claim 1, wherein the controller is configured to transmit the request for a low-latency preemption after an announcement of the low-latency preemption mode through a management frame by an access point.

6. The wireless device of claim 1, wherein the controller is configured to receive a preemption disallowed indication from a particular wireless device when the particular wireless device intends to transmit the low-latency frame in a following frame exchange.

7. The wireless device of claim 1, wherein the controller is configured to, in response to a frame from an access point that includes an indication for allowing a preemption request frame transmission in a transmission opportunity (TXOP), transmit a preemption request frame as the request for a low-latency preemption.

8. The wireless device of claim 7, wherein the indication includes at least one of (a) the preemption request frame transmission is allowed a SIFS after the frame and (b), the preemption request frame transmission is allowed a SIFS after an immediate response frame for the frame.

9. The wireless device of claim 7, wherein the controller is configured to obtain an information of a length of the immediate response frame by decoding a legacy signaling (L-SIG) field of a physical layer protocol data unit (PPDU) including an immediate response frame.

10. The wireless device of claim 7, wherein the indication is included in a physical layer (PHY) header of the frame.

11. The wireless device of claim 7, wherein the indication indicates whether a preemption request frame is allowed to be transmitted and an immediate response frame for the frame is to be transmitted by a recipient of the frame.

12. A communications system comprising:
a first wireless device configured to transmit a frame that indicates an enablement of a low-latency preemption mode; and
a second wireless device configured to receive frame, wherein the second wireless device is further configured to transmit a request for a low-latency preemption in response to the enablement of the low-latency preemption mode enable and then to transmit a low-latency frame to the first wireless device during a specified access period of the first wireless device.

13. The communications system of claim 12, wherein the first device is a transmission opportunity (TXOP) holder and wherein the second device is configured to transmit the low-latency frame during a TXOP of the TXOP holder.

14. The communications system of claim 12, wherein the low-latency preemption mode allows the second wireless device as a transmission opportunity (TXOP) responder and/or a non-TXOP responder to do the low-latency preemption during a TXOP of the first wireless device when a primary access category is a non-low-latency access category.

15. The communications system of claim 12, wherein the first wireless device is configured to transmit the frame after an announcement of the low-latency preemption mode through a management frame by an access point.

16. The communications system of claim 12, wherein the first wireless device is configured to transmit a preemption disallowed indication when the first wireless device intends to transmit a low-latency frame in a following frame exchange.

17. The communications system of claim 12, wherein the second wireless device is configured to, in response to a frame from an access point that includes an indication for allowing a preemption request frame transmission in a transmission opportunity (TXOP), transmit a preemption request frame as the request for a low-latency preemption.

18. The communications system of claim 17, wherein the indication includes at least one of (a) the preemption request frame transmission is allowed a SIFS after the frame and (b), the preemption request frame transmission is allowed a SIFS after an immediate response frame for the frame.

19. The communications system of claim 17, wherein the second wireless device is configured to obtain an information of a length of the immediate response frame by decoding a legacy signaling (L-SIG) field of a physical layer protocol data unit (PPDU) including an immediate response frame.

20. A method comprising:
receiving, by a second wireless device, an enablement of a low-latency preemption mode from a first wireless device;
transmitting, by the second wireless device, a request for a low-latency preemption to the first wireless device; and
transmitting, by the second wireless device, a low-latency frame to the first wireless device during a specified access period of the first wireless device.
